(19) United States
(12) Patent Application Publication
(10) Pub. No.: US 2007/0050622 A1
(43) Pub. Date: Mar. 1, 2007

(54) Method, system and apparatus for prevention of flash IC replacement hacking attack

(76) Inventors: Kent D. Rager, Gurnee, IL (US); Joseph M. Hansen, Williams Bay, WI (US); Keyur H. Khambholja, Mount Prospect, IL (US); Joel D. Voss, Elkhorn, WI (US)

Correspondence Address: INGRASSIA FISHER & LORENZ, P.C., 7150 E. CAMELBACK, STE. 325, SCOTTSDALE, AZ, 85251, US

(21) Appl. No.: 11/219,078

(22) Filed: Sep. 1, 2005

(51) Int. Cl. H04L 9/00

(52) U.S. Cl. 713/168

(57) ABSTRACT

Techniques are provided for preventing replacement of a one-time-programmable (OTP) component. The OTP component can be part of a wireless device. The wireless device is configured such that programming of a new IMEI code into the OTP component is permitted only when the wireless device is in a secure-mode state. A challenge-response protocol is used to place the wireless device in this secure-mode state.

### TECHNICAL FIELD OF THE INVENTION

The present invention generally relates to security for wireless communication devices, and more particularly, to techniques for preventing tampering with a wireless communication device.

### BACKGROUND OF THE INVENTION

To encourage use of their networks, operators of wireless networks often subsidize the cost of wireless devices by purchasing wireless devices from a manufacturer and then selling them to customers at a reduced cost or in some cases giving the wireless device to the customer at no cost. This is most often done in exchange for a promise from the customer to use the operator's access network (e.g., signing a service contract). The operator then hopes to recoup the cost of the wireless device from the customer via charging the customer for air time when the customer accesses the operator's network. To help ensure that this happens for the operator, some manufacturers implement a subsidy lock or subscriber identity module (SIM) lock by configuring the wireless device to be locked such that it only accepts SIM cards of a particular operator. If the customer attempts to use a SIM card from a different operator, the wireless device will not work and will display a message indicating that the wireless device is in a subsidy lock state. The customer will typically not have access to the password needed to unlock the wireless device.

Today, wireless device theft represents a viable international trade in which large numbers of wireless devices are stolen, reprogrammed, and then resold on the black market. For example, in some cases, organized crime rings may steal pallet loads of wireless devices and then hack into the wireless devices to unlock them so that the wireless devices can be resold on the black market. In this case, the operator who purchased the wireless devices can lose its investment to subsidize the cost of the wireless devices. Accordingly, it would be desirable to provide techniques which can help protect the subsidy or SIM locks from hacking attacks.

To help reduce the incentive to steal a wireless device, many wireless devices are assigned a unique code or terminal identity, commonly referred to as an International Mobile Equipment Identity (IMEI) code. The IMEI is a type of serial number which can be used by an access network to identify a wireless device. Wireless devices may store the IMEI in a one-time-programmable (OTP) location (e.g., register) within a Flash memory integrated circuit (IC) of the wireless device. Other implementations of secure IMEI storage rely on digital signature techniques to ensure the integrity of the IMEI, rather than using OTP memory.

In some access network deployments, the access network requests the IMEI from the wireless device. For example, in GSM signaling protocols, the wireless device sends the IMEI if requested by the network. The access network compares the received IMEI code to a central equipment identity register (CEIR) database which contains a “blacklist” of IMEIs that have been reported as stolen. If the IMEI of the wireless device has been reported stolen and is on this CEIR blacklist, then the access network denies access to the network when the caller attempts to make a call. To thwart the IMEI check, sophisticated thieves utilize hacking techniques to reprogram the IMEI in a stolen wireless device, and the stolen wireless device can transmit a seemingly legitimate IMEI code and will be allowed to make calls over the access network.

Some wireless device manufacturers implement secure boot techniques which can be used to verify digital signatures on executable code of the wireless device before executing it. This helps to ensure that authentic software is running that reads the IMEI from the OTP memory, and not from some other place of the hacker's choice. In other implementations, the software can read the IMEI from the Flash memory IC and verify the signature computed over the IMEI value and a unique hardware ID before using the IMEI. This supports wireless device blacklisting by helping to make the IMEI secure from unauthorized modification.

In addition, subsidy locking parameters (SLPs) can be implemented which can be stored in an integrity-protected manner utilizing a secret hardware encryption key. These values must be initialized during initial manufacture. If the IMEI is stored in an OTP memory, then the state of the IMEI (e.g., whether or not the IMEI is programmed) can be used to determine whether the device is in the initial manufacture state.

For instance, a cryptographic hash check against a decrypted hash can be used to detect tampering. In one such implementation, encrypted hash digests can be used to protect integrity. In such an implementation, a cryptographic hashing algorithm such as SHA-1 or MD5 is used to compute a hash digest value on the data to be protected. The resulting hash digest value is encrypted via the hardware encryption key. To check for tampering, the hash digest is recomputed over the protected data and compared against the decrypted hash digest.

In other implementations, a CRC check against a decrypted CRC can be used to detect tampering. For example, a CRC is computed over the SLP data and appended to the end. This concatenated data is encrypted via the hardware encryption key that is statistically random in every device. To detect tampering with the raw SLP data, a CRC check can be used, after decryption, to verify that a CRC computed over the decrypted SLP data matches the decrypted CRC. If this matches, this ensures that the encrypted value has decrypted successfully. If the value has not decrypted successfully, then the device may power off. When a wireless device powers up for the first time after manufacture, the encrypted values in these SLPs can be initialized by having the wireless device check to determine whether these values are missing. The wireless device can also determine if the IMEI is programmed in the one-time programmable (OTP) component, such as a user protection register of a Flash memory. If the IMEI is not programmed in the OTP memory, then the wireless device can initialize the SLPs to an encrypted representation that indicates a “not subsidy locked” state. By this, these SLP values will be initialized to a value that decrypts successfully, such that the phone will not power down. These techniques can help keep the SLPs secure from unauthorized unlocking and thereby protect operator subsidies of wireless devices.

Manufacturers and regulatory bodies alike have realized that hackers will continue to develop new techniques for tampering with the IMEI value to defeat the IMEI check. As such, standards bodies, such as the GSM Association and ETSI, have issued a Memorandum of Understanding (MOU), titled “Security Principles Related to Handset Theft,” ETSI/3GPP spec 122.016. The MOU enunciates nine security principles relating to wireless devices, and specifies a number of high level measures for protecting the IMEI and the platform on which IMEI mechanism is stored. The goal of the MOU is to provide guidelines for making wireless devices more resistant to tampering with the IMEI and subsidy lock parameters. Ideally, the integrity of the IMEI value should be protected by restricting write access to the IMEI value. For example, write access to the IMEI value might only be permitted by a manufacturer-determined mechanism.

Notwithstanding the advances mentioned above, further improvements are needed to protect the IMEI from new types of hacker attacks. The ninth security principle mentioned in the MOU seeks to prevent tampering with the IMEI and subsidy lock parameters by replacement of any component on the wireless device including memory components. For example, a hacker might remove the OTP component that contains the IMEI and replace the OTP component with other pre-programmed OTP components.

Thus, there is a need for techniques that can prevent replacement of an IMEI value by substitution of hardware components. There is also a need to provide techniques that are resistant to attacks on the IMEI or subsidy lock parameters by replacing OTP components of the wireless device. Other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

The present invention will be described in conjunction with the following drawing figures, wherein like numerals denote like elements, and

FIG. 1 is a block diagram of a communication system according to one embodiment;

FIG. 2 is a block diagram of a wireless device for use in the communication system of FIG. 1 according to one embodiment;

FIG. 3 is a flow diagram of a technique that can protect an IMEI by preventing replacement or substitution of hardware components in a wireless device according to one embodiment;

FIG. 4 is a flow chart showing an exemplary technique which can protect an IMEI by preventing replacement or substitution of hardware components in a wireless device according to one embodiment; and

FIG. 5 is a flow chart showing an exemplary technique for determining whether the programming station is a trusted programming station according to one embodiment.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

Security Architecture

A processor in a wireless device has a hardware block known as the security controller. The security controller includes a hardware implementation of an encryption algorithm, such as triple DES (3-DES) or AES. This encryption algorithm uses a random key variable that is unique to each wireless device. The random key variable is embedded in a set of laser fuses in the processor and is not readable by the software. If the manufacturer has data to be secured and stored in a Flash memory of the wireless device, then the manufacturer can encrypt it with this encryption algorithm. As a result, the resulting data stored in the Flash memory is secure. Even if a hacker can access the data in the Flash memory, the hacker does not have access to the random key variable and therefore is unable to decrypt the data. Moreover, if a hacker tries to use the secured data in a different wireless device, the data will not decrypt successfully since each wireless device has a differing random key variable.

An encryption/decryption technique to detect tampering with data stored in the Flash memory of the wireless device will now be described. This technique can be used to establish trust that the subsidy lock parameters or data values stored on the Flash memory are trustworthy when they are needed. An authentication code can be computed over the data values in the form of a cryptographic hash or cyclical redundancy check (CRC), as described above.

For example, in one embodiment, to encrypt a data element for storage in the Flash memory of the wireless device, the data element is run through a cyclical redundancy check (CRC) which computes an authentication code value over that data element and appends the authentication code to the data element. An authentication code may comprise either a CRC or cryptographic hash digest value. For example, to encrypt a data element for storage in the Flash memory of the wireless device, a cryptographic hash check or CRC check can be used. The concatenated data (i.e., data element with authentication code) is then passed through an encryption engine which encrypts the concatenated data using the random key variable to produce an encrypted result which is stored in the Flash memory. Depending on the implementation, either all of the concatenated data or just the authentication code portion of the concatenated data can be encrypted. If the data portion of the concatenated data does not need to be secret, then only the authentication code portion of the concatenated data can be encrypted to protect the integrity.

To decrypt the data element, the process is reversed. The encrypted result is taken from the Flash memory and run through a decryption engine using the random hardware key variable to generate a string of data which comprises a data element field and an authentication code field. The data element field is run through a CRC or cryptographic hash algorithm which re-computes the authentication code over the data element field to determine if the bits in the authentication code field are valid by comparing the computed authentication code to the decrypted authentication code. If the computed authentication code and the decrypted authentication code match, then decryption of the data element is successful and the data element can be trusted as having an untampered value. If the computed authentication code and the decrypted authentication code do not match then it is assumed the encrypted value from the Flash memory has been tampered with and the wireless device can be placed in a state where the wireless device stops running and can not be used from that point forward.

When a wireless device powers up for the first time after manufacture, the wireless device has not yet been programmed. In this situation, the wireless device goes through an initialization routine which examines the Flash memory to determine whether integrity-protected data values are present. In one implementation, the integrity protected data values can be encrypted values. If the wireless device determines that the integrity-protected data values are not present, and if the IMEI has not been programmed, then the wireless device initializes the integrity-protected data values with encrypted values. If the IMEI has already been programmed, this initialization is not done. Thus, if a hacker were to erase or otherwise modify the Flash memory that contains these integrity-protected values (in a phone whose IMEI is programmed), these values will not be re-initialized by the phone. This results in the phone detecting the tampering and handling it by stopping execution.

Storing the IMEI in an OTP component and storing SLPs with integrity protection by itself does not address the goal of preventing such modification by replacement of components (e.g., by replacement of the Flash memory with a blank Flash memory). By the previously discussed algorithms alone, replacement of the Flash memory with a blank Flash memory not having the IMEI programmed in the OTP component returns the device to the initial manufacturing state. By reinstalling authentic software, the phone initializes the SLPs to values which are not subsidy locked and any IMEI may be programmed into the OTP component.

To address this issue, recall that during initial manufacture, the wireless device has not yet been programmed with an IMEI. The encrypted elements are initialized to default integrity-protected values. With respect to the subsidy lock feature, these default values now correspond to the wireless device being locked to accept only test SIM cards. In order to reprogram these values to values that correspond to a subsidy unlocked device, and also, in order to program the IMEI value, the phone must first be placed into a secure-mode state. A challenge/response method utilizing a secure server as described below is used to place the phone into the secure-mode state. Before the wireless device is shipped, the IMEI is programmed. The IMEI is stored in a physical OTP component (e.g., register) in the Flash memory. Once the IMEI is programmed it can not be changed since it is “one-time programmable.” Therefore, after that point if a hacker attempts to erase the Flash memory and place the wireless device in its “initial manufacture” state, the state of the IMEI can not be changed, since it has already been programmed. Thus, when the wireless device powers up, it will detect that the integrity-protected values are missing, but that the IMEI has been programmed. The wireless device will not initialize the values at that point.

Furthermore, if the hacker replaces the Flash memory with a blank Flash memory that does not have the IMEI programmed in the OTP component, the phone will now initialize these integrity-protected values such that the phone is subsidy locked to only a test SIM. This is not a useful state for the hacker to be able to resell the phone. Since the hacker will not have access to an authenticated programming station to complete the challenge/response protocol, the hacker will not be able to program a new IMEI or unlock the phone from this state. Thus, this algorithm has prevented the hacker from successfully changing the IMEI and from subsidy unlocking the device via replacement of the Flash memory component as required by the Security Principles Related to Handset Theft document's ninth principle.

Overview

Embodiments of the present invention provide techniques for preventing replacement of a one-time-programmable (OTP) component, such as a memory, which contains an International Mobile Equipment Identity (IMEI) code. The OTP memory can be part of a wireless device. The wireless device is configured such that programming of an IMEI value into the OTP memory is permitted only when the wireless device is in a “secure-mode state.” A challenge-response protocol is used to place the wireless device in this secure-mode state. A secure test command can be implemented to perform a challenge-response such that programming of an IMEI value to an OTP register is allowed only when a wireless device is in the secure-mode state. For example, the challenge-response protocol can be used to confirm that a station attempting to program the wireless device is authorized to program the wireless device. In one implementation, this can be accomplished by authenticating the station at a secure server, and communicating the authentication to the wireless device. Communicating the authentication to the wireless device can involve, for example, encrypting a random number generated by the wireless device using a private key which is unique to the secure server to generate an encrypted result, and then transmitting the encrypted result to the wireless device. Optionally, the wireless device can allow overwriting of encrypted subsidy lock parameters only when the wireless device is in the “secure-mode state.” The wireless device can initially power up into a subsidy locked state, and the challenge-response protocol can be used to place the wireless device in a subsidy unlocked state.

Exemplary Wireless Communication System

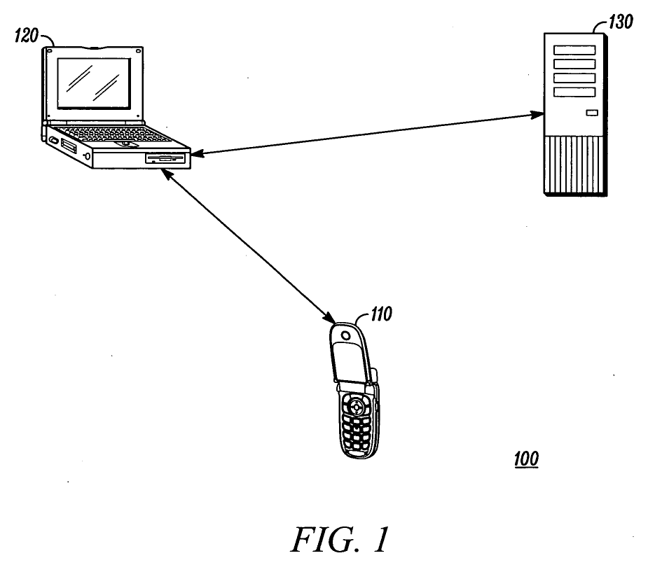

FIG. 1 is a block diagram of a communication system 100 according to one embodiment.

The communication system 100 has a wireless device 110, a programming station 120 and a secure server 130. The wireless device 110 communicates with the programming station 120 over a communication link which can be either wired or wireless. The programming station 120 communicates with the secure server 130 over another communications link which can be either wired or wireless.

The wireless device 110 includes hardware with which an access network communicates. A wireless device may be mobile or stationary and can include devices that communicate through a wireless channel or through a wired channel. A wireless device may further be any of a number of types of devices including but not limited to PC card, compact flash, external or internal modem, wireless or wireline device, or personal digital assistant (PDA). In one implementation, the wireless device comprises a mobile telephone which can also be called a mobile station (MS), mobile equipment (ME) or user equipment (UE).

The programming station 120 includes a host computer which has two-way access to other computers. The programming station 120 can be a device or program that provides services to another device or program, such as the wireless device 110. The programming station 120 could be, for example, a personal computer which is coupled to the wireless device 110 for programming the wireless device 110.

The secure server 130 is implemented here as a computer which provides services to other computer programs in the same or other computers. The secure server 130 can be a program that awaits and fulfills requests from client programs in the same or other computers, such as the programming station 120. The secure server 130 can be controlled, for example, by the manufacturer of the wireless device 110.

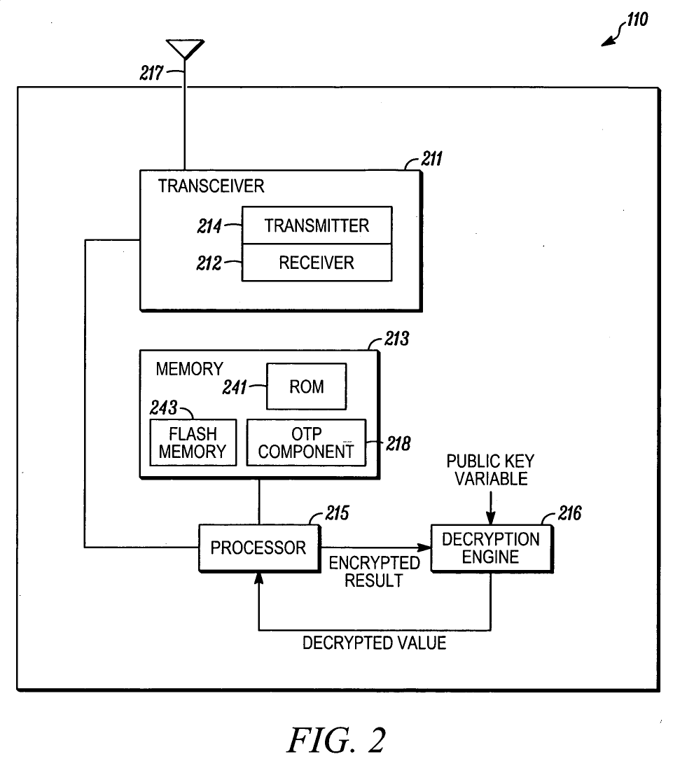

FIG. 2 is a block diagram of a wireless device 110 for use in the communication system of FIG. 1 according to one embodiment. The wireless device 110 comprises a transceiver 211, a memory 213, a processor 215, a decryption engine 216, and an antenna 217. The transceiver 211 includes a receiver 212 and a transmitter 214. The memory 213 includes, among other things, a Read Only Memory (ROM) 241, a reprogrammable Flash memory 243 and a one-time-programmable (OTP) component 218, such as a Flash memory. The OTP component 218 is initially unprogrammed and can be programmed with an International Mobile Equipment Identity (IMEI) code or value. Among other parameters, the reprogrammable Flash memory can optionally store encrypted subsidy lock parameters (SLPs).

The programming station 120 shown in FIG. 1 can generate a secure test command which instructs the wireless device 110 to enter a secure-mode state.

The receiver 212 can receive the secure test command which instructs the wireless device 110 to enter a secure-mode state. The receiver 212 can receive the secure test command, for example, over a USB interface (not shown) or wirelessly via the antenna 217.

Responsive to the secure test command, the processor 215 can generate a first message comprising a random number and optionally a unique ID of the wireless device 110, such as an IMEI, and hash of a public key value. Because different wireless devices 110 can have different public keys, the hash of the public key value tells the secure server 130 which private key the secure server 130 should use to encrypt the random number or alternatively compute a signature on the random number value. The wireless device 110 can then use the public key value to verify the encrypted value or signature that the secure server 130 returns to the wireless device 110. In one implementation, the public key could be used to decrypt the returned value. Then the decrypted value is checked if it matches the random number originally sent to the programming station. In an alternative implementation, the public key could be used to perform a digital signature validation on the returned data. If the signature validation is successful, the random number returned is also checked if it is the same random number that was originally sent. In either implementation, if the returned random number matches that value originally sent, then the phone has established that it can trust the programming station and it enters the secure-mode state. The transmitter 214 can transmit the first message to the programming station 120, which in turn forwards the first message to the secure server 130.

The processor 215 can permit programming of an IMEI value into the OTP component 218 to replace the IMEI code only if the wireless device 110 is in a secure-mode state. As will be described below, the wireless device 110 enters the secure-mode state if trust can be established between the wireless device 110 and the programming station 120 via the secure server 130. As described in greater detail below with reference to FIGS. 1 and 3-5, trust can be established between the wireless device 110 and the programming station 120 if a challenge-response protocol is satisfied between the wireless device 110, the programming station 120, and the secure server 110. In addition, the processor 215 permits programming new values into the encrypted SLPs when the wireless device 110 is SIM-locked only if the wireless device 110 is in the secure-mode state. When the wireless device 110 powers on the processor 215 determines whether the IMEI has been programmed into the OTP component 218.

An International Mobile Subscriber Identifier (IMSI) is a value on the SIM card which defines a home network and a particular subscriber within that network. If the processor 215 determines that the IMEI has not been programmed into the OTP component 218, then processor 215 initializes the SLPs with encrypted values that lock the wireless device 110 to only accept test SIM cards having an IMSI beginning, for example, with 001-01.

The Challenge-Response Protocol

The secure server 130 authenticates the programming station 120 to confirm that the programming station 120 is authorized to program the wireless device 110.

The secure server 130 includes, among other things, an encryption engine (not shown). Once the secure server 130 receives the random number, the encryption engine in the secure server 130 can encrypt the random number using an asymmetric private key variable which exists only on secure server 130 and which is associated with the public key hash sent from the wireless device 110. The encryption engine of the secure server 130 generates an encrypted result by encrypting the random number using a private key variable.

In another implementation, once the secure server 130 receives the random number, the secure server 130 can use asymmetric encryption techniques, which are generally described below, to compute a hash value of the random number and encrypt the hash value using a private key, which exists only on secure server 130 and which is associated with the public key hash sent from the wireless device 110, to generate a digital signature computed over the random number. The secure server 130 sends the encrypted value (or signature value), and optionally a security-level parameter or parameters that specify which operations can be done to the wireless device 110, to the programming station 120. The security-level parameter is part of the encrypted value or signed data where a signature is used.

Asymmetric Encryption

In this case, asymmetric encryption can be used for authentication to compute a hash digest over the data to be authenticated. The hash digest can be computed, for example, using the SHA-1, SHA-256, or MD5 algorithms. The resulting hash value can be encrypted using an asymmetric private key to form a digital signature.

The authenticating device also computes the hash digest over the data to be authenticated and it utilizes an asymmetric public key to decrypt the digital signature. The computed hash digest is compared to the decrypted hash digest and if they match, then the data has been authenticated.

If the device secures the public key from being changed, and the private key for generating the signature is limited to authorized users, then the data cannot be modified by unauthorized persons, because they do not have access to the private key needed to generate a valid signature on the modified data.

Returning to FIG. 1, the wireless device 110 knows the random number it originally sent to the programming station 120. The wireless device 110 uses its public key variable, which is hard-coded in the memory 213 of wireless device 110, to validate the encrypted result it receives from the programming station 120 (which came from the secure server 130). For example, the wireless device 110 can use its public key to decrypt the encrypted result or to verify the signature with the random number. As shown in FIG. 2, the decryption engine 216 of the wireless device 110 decrypts the encrypted result using the public key variable to generate a decrypted value that is the same as the random number. Once this happens, the wireless device 110 knows that it can “trust” the programming station 120 because the programming station 120 must go through an authentication procedure with the secure server 130 such that only programming stations 120 authorized to communicate with the secure server 130 are authenticated.

Optionally, the decryption engine 216 can also decrypt the encrypted result to generate a security-level parameter. The security-level parameter establishes multiple levels of access to certain capabilities in the wireless device 110 for different users and specifies which operations can be done to the wireless device 110 by the programming station 120.

Once in the secure-mode state, an IMEI value can be programmed into the OTP component 218. In addition, a timer is set which allows the wireless device 110 to stay in the secure-mode state for a limited duration (e.g., one minute) so that the wireless device 110 does not remain in the secure-mode state indefinitely.

When the wireless device 110 powers on, it establishes trust of the software in the flash memory 213 via a secure boot mechanism. The secure boot mechanism utilizes a trusted public key to verify a digital signature on the software image. Trust of the public key may be established by hard-coding the key in an unchangeable ROM memory. Alternatively, the public key may be stored in the flash memory and a hash digest of that key is stored in the ROM memory or in an OTP component and validated before using the public key. A private key is needed to generate the digital signature on the software. By keeping the private key secret outside of the phone, unauthorized modifications cannot be made to the software, since the private key would not be known to generate a new valid signature on the modified software. The secure boot mechanism establishes trust that the security mechanism implemented in software will execute as intended. The processor 215 determines whether the IMEI has been programmed into the OTP component 218. The secure boot mechanism can be used to verify digital signatures on executable code of the wireless device 110 before executing it to help ensure that authentic software is running that reads the IMEI from the OTP component 218, and not from some other place of the hacker's choice.

Optionally, the processor 215 can permit programming new values into the encrypted subsidy lock parameters (SLPs), contained in the OTP component 218, when the wireless device 110 is locked only if the wireless device 110 is in the secure-mode state. For example, if the wireless device 110 determines that the IMEI has not been programmed into the OTP component 218 when the wireless device 110 powers on, then wireless device 110 initializes the SLPs with encrypted values that lock the wireless device to only accept test SIM cards having an IMSI beginning, for example, with 001-01. To unlock the phone from this state to allow it to use “live” SIM cards issued by a network operator, the phone must be placed into the secure-mode state via the secure test command. Once in this state, the phone will permit the SLP values to be overwritten with new values that permit the phone to accept SIM cards issued by one or more network operators.

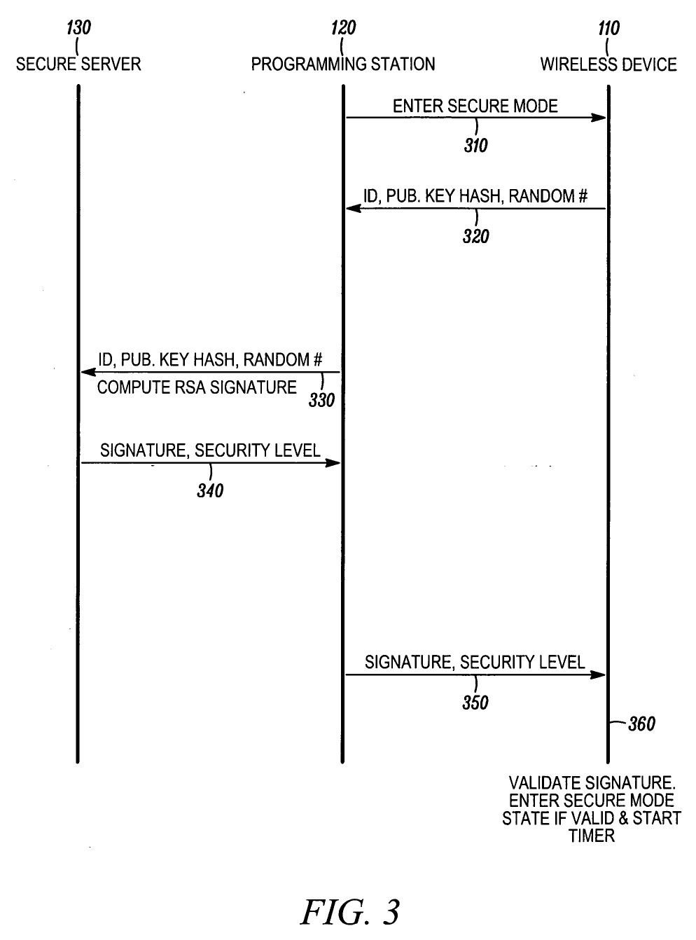

FIG. 3 is a flow diagram 300 of a technique which can protect an IMEI by preventing replacement or substitution of hardware components in a wireless device 110 according to one embodiment. In this embodiment, a secure or “challenged” test command can be used to implement the GSM Association's ninth security principle.

At step 310, a programming station 120 connected to the wireless device 110 can send a new “enter secure mode” command to the wireless device 110. At step 320, the wireless device 110 responds by returning a first message which includes, at least, a random number to the programming station 120. The first message can also include other information such as a public key hash and ID as described above. At step 330, the programming station 120 must then forward the first message to a secure server 130 which authenticates the programming station 120. If the secure server authenticates the programming station, the secure sever will encrypt the random number using a private key variable. At step 340, the secure server 130 generates an encrypted result and sends the encrypted result to the programming station 120. The encrypted result may comprise, for example, an encrypted digital signature and security level parameters. At step 350, the programming station 120 sends the encrypted result to the wireless device 110.

At step 360, the wireless device 110 decrypts the encrypted result using a trusted public key variable stored in the wireless device 110. If this decrypted value includes the same value as the original random number sent to the programming station 120, then the wireless device 110 has established trust with the programming station 120 by confirming that the programming station 120 had access to the secure server 130. The wireless device 110 then enters a secure-mode state.

After the wireless device 110 enters the secure-mode state, the security level parameters can then used to gate whether certain operations are permitted in the wireless device 110, such as the ability to program an IMEI value or the ability to program new values into the encrypted subsidy-locking parameters. The security-level parameter(s) can be used to establish multiple levels of access to certain capabilities in the wireless device 110 for different programming stations.

When the wireless device 110 powers on and establishes trust of the software via the secure boot mechanism, the wireless device 110 checks whether the IMEI has been programmed into the OTP component 218 (shown in FIG. 2). If not, the secure subsidy-locking parameters are initialized with encrypted values that lock the wireless device 110 to only accept test SIM cards (e.g., SIM cards whose IMSI begins with 001-01). Furthermore, the wireless device 110 only permits the IMEI to be programmed into the OTP component 218 when the wireless device 110 is in the secure-mode state. The secure subsidy-locking parameters values are writeable when the wireless device 110 is either (1) unlocked, or (2) when locked if the wireless device 110 has been put into the secure-mode state.

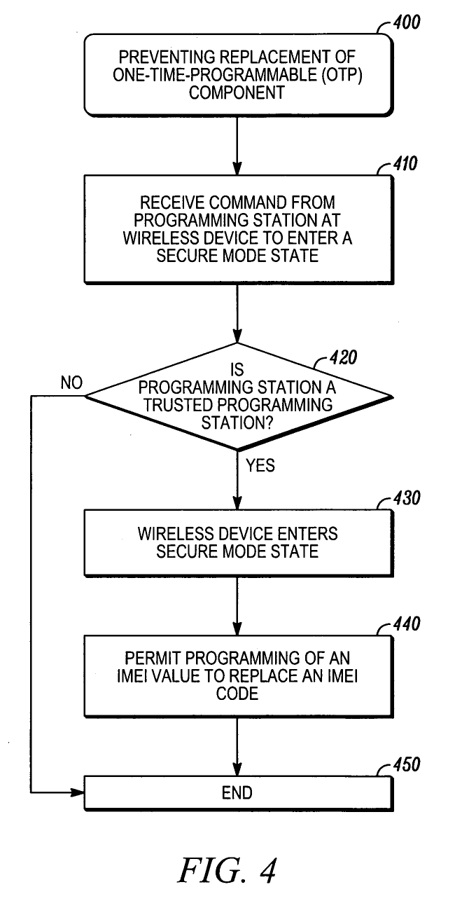

FIG. 4 is a flow chart showing an exemplary technique 400 which can protect an IMEI by preventing replacement or substitution of hardware components, such as, a one-time-programmable (OTP) component 218 in a wireless device 110 (shown in FIG. 2) which contains an International Mobile Equipment Identity (IMEI) code and possibly encrypted subsidy lock parameters (SLPs). This technique can be used, for example, in a wireless communication system comprising a secure server 130, a programming station 120, and the wireless device 110 (shown in FIG. 1).

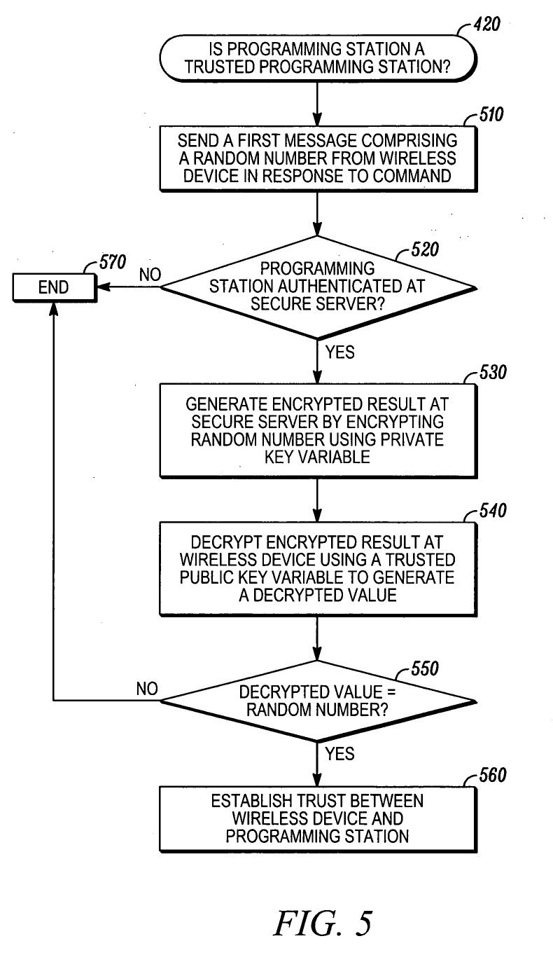

At step 410, a command from the programming station 120 is received to enter a secure-mode state at the wireless device 110. At step 420, it can be determined whether the programming station 120 is a “trusted” programming station. One implementation of this step will be described below with reference to FIG. 5. If it is determined at step 420 that the programming station 120 is not a trusted programming station, then at step 450, the process ends and the wireless device 110 remains locked such that the programming station 120 is not permitted to program an IMEI value or program new values into encrypted subsidy-locking parameters which are stored in the wireless device 110.

If it is determined at step 420 that the programming station 120 is a trusted programming station, then at step 430, the wireless device 110 enters a secure-mode state. After it has been confirmed that the programming station 120 is a trusted programming station and the wireless device 110 is in the secure-mode state, then at step 440, the programming station 120 is permitted to program an IMEI value to replace the IMEI code or optionally program new values into encrypted subsidy-locking parameters which are stored in the wireless device 110.

FIG. 5 is a flow chart showing an exemplary technique 420 for determining whether the programming station 120 is a trusted programming station according to one embodiment. To determine whether the programming station 120 is a “trusted” programming station, the following technique can be used.

At step 510, the wireless device 110 responds to the secure test command from the programming station 120 by returning to the programming station 120 a first message comprising a random number. As explained above, the first message could also include, for example, an ID and a public key hash. The programming station forwards the first message to the secure server 130.

At step 520, it is determined whether the programming station 120 has been authenticated by the secure server 130 to confirm that the programming station 120 is authorized to program the wireless device 110.

If the secure server 130 determines that the programming station is not authorized to program the wireless device 110, and the programming station 120 can not be authenticated by the secure server 130, then the process ends at step 570.

If the secure server 130 authenticates the programming station 120 at step 520 (e.g., confirms that the programming station 120 is authorized to program the wireless device 110), then at step 530, the secure server 130 can generate an encrypted result by encrypting the random number using a private key variable. The secure server 130 can send the encrypted result to the programming station 120, which in turn sends the encrypted result to the wireless device 110.

At step 540, the wireless device 110 decrypts the encrypted result using a trusted public key variable stored in the wireless device 110 to generate a decrypted value, and optionally, a security-level parameter which establishes multiple levels of access to certain capabilities in the wireless device 110 for different programming stations 120. At step 550, the wireless device 110 determines whether the decrypted value matches the random number. If the decrypted value is not the same as the random number, then the process ends at step 570. If the decrypted value is the same as the random number, then at step 560, the wireless device 110 has established trust with the programming station 120.

Prevention of Part Replacement Attack

With the implementations described above, if a hacker attempts to remove the OTP component 218, replace it with a new blank OTP memory, and then reinstall the signed phone executable code, the wireless device 110 will power up and detect that the IMEI is no longer programmed. Consequently, the wireless device 110 will only accept test SIM cards, and the wireless device 110 will be rendered useless to the hacker. Because the hacker does not have access to the secure server 130, the hacker is unable to put the wireless device 110 into the secure-mode state. Consequently, the hacker is unable to reprogram the IMEI. (It should be appreciated that the IMEI is stored encrypted via a unique hardware encryption key of the wireless device 110, such that the IMEI from another wireless device 110 cannot be copied into the wireless device 110 being hacked and pre-programmed using external programming tools such as a Data I/O.) Since the hacker cannot reprogram the IMEI, the hacker can only put the original IMEI value back into the wireless device 110 by programming it externally on a data I/O before placing the new OTP memory in the wireless device 110. Consequently, the hacker can be prevented from changing the IMEI even though the OTP component 218 was replaced.

If the hacker replaces the OTP component 218 with a new OTP memory not having the IMEI programmed, the wireless device 110 initializes itself to be locked such that it only accepts test SIM cards. In this scenario, there is no unlocking password that can be entered to unlock that condition. The only way to unlock this condition is to enter the secure-mode state, which the hacker cannot do.

On the other hand, if the hacker replaces the OTP component 218 with a new OTP memory that has the original encrypted IMEI value pre-programmed via some external programming device, then the wireless device 110 will not initialize the subsidy-locking parameters. Therefore, these values will not successfully decrypt unless their raw encrypted values from the OTP component 218 were also pre-programmed in the new OTP memory. Therefore, the wireless device 110 will refuse to power up. If the hacker copied the original encrypted subsidy-locking values, then the original encrypted subsidy-locking values would decrypt, but the wireless device 110 would continue to be locked and would have the same IMEI as it originally did.

Thus, via the techniques described above, the wireless device 10 can prevent replacement of an OTP component, such as a flash IC, and is compliant to the GSM Association's ninth security principle.

The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical. Furthermore, numerical ordinals such as “first,” “second,” “third,” etc. simply denote different singles of a plurality and do not imply any order or sequence unless specifically defined by the claim language.

Furthermore, words such as “connect” or “coupled to” used in describing a relationship between different elements do not imply that a direct physical connection must be made between these elements. For example, two elements may be connected to each other physically, electronically, logically, or in any other manner, through one or more additional elements, without departing from the scope of the invention.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments.

It should also be understood that various changes can be made in the function and arrangement of elements without departing from the scope of the invention as set forth in the appended claims and the legal equivalents thereof. Thus, the present invention is not intended to be limited to the embodiments shown herein but is to be accorded the widest scope consistent with the principles and novel features disclosed herein.

What is claimed is:

1. A method for preventing replacement of a one-time-programmable (OTP) component in a communication device programmable with an International Mobile Equipment Identity (IMEI) code, comprising:
configuring the communication device such that programming of an IMEI code into the OTP component is permitted only when the communication device is in a secure-mode state; and
using a challenge-response protocol to place the communication device in the secure-mode state.

2. The method of claim 1, wherein using a challenge-response protocol to place the communication device in the secure-mode state, comprises:
confirming that a programming station attempting to program the communication device is authorized to program the communication device.

3. The method of claim 1, wherein configuring the communication device comprises:
causing the communication device to initially power up into a subsidy locked state; and
receiving a command to place the communication device in a subsidy unlocked state after the communication device is placed in the secure-mode state.

4. A method for preventing replacement of a one-time-programmable (OTP) component in a communication device programmable with an International Mobile Equipment Identity (IMEI) code, comprising:
receiving a command from a programming station at the communication device to enter a secure-mode state;
determining whether the programming station is a trusted programming station;
entering a secure-mode state if the programming station is a trusted programming station; and
permitting programming of an IMEI code into the OTP component if the communication device is in the secure-mode state.

5. The method of claim 4, wherein determining whether the programming station is a trusted programming station, comprises:
sending a first message comprising a random number from the communication device to the programming station in response to the command;
authenticating the programming station at a secure server to confirm that the programming station is authorized to program the communication device;
generating an encrypted result at the secure server by encrypting the random number using a private key variable, if the secure server authenticates the programming station;
decrypting the encrypted result at the communication device using a trusted public key variable stored in the communication device to generate a decrypted value; and
establishing trust between the communication device and the programming station if the decrypted value is the same as the random number.

6. The method of claim 5, wherein decrypting the encrypted result at the communication device using a trusted public key variable stored in the communication device to generate a decrypted value, further comprises:
decrypting the encrypted result at the communication device using a trusted public key variable stored in the communication device to generate a decrypted value and a security-level parameter.

7. The method of claim 6, wherein the security-level parameter is assigned by the secure server per its authorization of the programming station and a user of the programming station, and establishes multiple levels of access to certain capabilities in the communication device for different programming stations.

8. The method of claim 4, wherein the communication device permits programming new values into encrypted subsidy lock parameters (SLPs) of a reprogrammable memory when the communication device is locked if the communication device is in the secure-mode state or if the communication device is unlocked.

9. The method of claim 8, further comprising:
initializing the SLPs with encrypted values that lock the communication device, if the IMEI has not been programmed into the OTP component when the communication device powers on.

10. The method of claim 4, wherein determining whether the programming station is a trusted programming station, comprises:
sending a first message comprising a first random number from the communication device in response to the command;
authenticating the programming station at a secure server to confirm that the programming station is authorized to program the communication device;
generating a signature at the secure server based on the first random number using a private key variable, if the secure server authenticates the programming station;
decrypting the signature at the communication device using a trusted public key variable stored in the communication device to generate a decrypted hash value;
computing a computed hash value at the communication device using received data;
comparing the decrypted hash value to the computed hash value; and
establishing trust between the communication device and the programming station if a second random number in the received data is the same as the first random number.

11. A system, comprising:
a programming station configured to generate a command; and
a communication device configured to receive the command, wherein the command instructs the communication device to enter a secure-mode state, the communication device comprising:
a one-time-programmable (OTP) component programmable with an International Mobile Equipment Identity (IMEI) code; and
a processor configured to permit programming of an IMEI code into the OTP component only if the communication device is in the secure-mode state.

12. The system of claim 11, wherein the system further comprises:
a secure server, wherein trust is established between the communication device and the programming station if a challenge-response protocol is satisfied between the communication device, the programming station, and the secure server.

13. The system of claim 11, wherein the processor is configured to generate, responsive to the command, a first message comprising a random number, and wherein the communication device is further configured to transmit the first message to the programming station.

14. The system of claim 13, wherein the communication device further comprises a decryption engine, and a second memory configured to store a trusted public key variable, wherein the secure server comprises an encryption engine, and wherein the challenge-response protocol is satisfied if:
the secure server authenticates the programming station to confirm that the programming station is authorized to program the communication device,
the encryption engine generates an encrypted result by either:
encrypting the random number from the first message using a private key variable, or
encrypting a cryptographic hash of the random number from the first message using a private key variable, and
the decryption engine decrypts the encrypted result using the trusted public key variable to generate a decrypted value that matches the random number that was sent in the first message.

15. The system of claim 14, wherein the processor determines whether the communication device is in an initial manufacturing state based upon a state held in an OTP component when the communication device powers on.

16. The system of claim 15, wherein the communication device further comprises a reprogrammable memory, and wherein the reprogrammable memory initially contains encrypted subsidy lock parameters (SLPs), and wherein the processor permits programming new values into the encrypted SLPs when the communication device is locked only if the communication device is in the secure-mode state.

17. The system of claim 13, wherein the communication device further comprises a decryption engine, and a second memory configured to store a trusted public key variable, wherein the secure server comprises an encryption engine, and wherein the challenge-response protocol is satisfied if:
the secure server authenticates the programming station to confirm that the programming station is authorized to program the communication device,
the encryption engine generates an encrypted result by either:
encrypting the random number from the first message using a private key variable, or
encrypting a cryptographic hash of the random number from the first message using a private key variable, and
the decryption engine decrypts the encrypted result using the trusted public key variable to generate a decrypted value that matches a hash of the random number that was sent in the first message.

18. A communication device, comprising:
a receiver configured to receive a command from a programming station, wherein the command instructs the communication device to enter a secure-mode state;
a one-time-programmable (OTP) component configured to receive an International Mobile Equipment Identity (IMEI) code, wherein the OTP component is initially unprogrammed; and
a processor configured to permit programming of an IMEI code into the OTP component only if the communication device is in the secure-mode state, wherein the communication device enters the secure-mode state once trust is established between the communication device and the programming station.

19. The communication device of claim 18, wherein the communication device further comprises:
a reprogrammable memory which initially contains encrypted subsidy lock parameters (SLPs), and wherein the processor permits programming new values into the encrypted SLPs when the communication device is locked only if the communication device is in the secure-mode state.

20. The communication device of claim 19, wherein the processor determines whether the IMEI has been programmed into the OTP component when the communication device powers on, and if the processor determines that the IMEI has not been programmed into the OTP component when the communication device powers on, then the processor initializes the SLPs with encrypted values that lock the communication device to only accept test SIM cards.

21. The communication device of claim 18, wherein the communication device further comprises:
a transmitter;
a decryption engine;
a second memory configured to store a trusted public key variable, and
wherein the processor is configured to generate, responsive to the command, a first message comprising a random number; and
a transmitter configured to transmit the first message to the programming station.

22. The communication device of claim 21, wherein a challenge-response protocol to establish trust between the wireless device and the programming station is satisfied if a secure server comprising an encryption engine authenticates the programming station to confirm that the programming station is authorized to program the communication device and the encryption engine generates an encrypted result by encrypting the random number using a private key variable, and
the decryption engine decrypts the encrypted result using the trusted public key variable to generate a decrypted value that is the same as the random number.

23. The communication device of claim 22, wherein the decryption engine decrypts the encrypted result using a trusted public key variable stored in the communication device to generate a decrypted value that is the same as the random number and a security-level parameter, wherein the security-level parameter establishes multiple levels of access to certain capabilities in the communication device for different users.
